(19) United States
(12) Patent Application Publication
(10) Pub. No.: US 2013/0138393 A1
(43) Pub. Date: May 30, 2013

(54) INCLINOMETER

(71) Applicant: Karl S. Weibezahn, Corvallis, OR (US)

(72) Inventor: Karl S. Weibezahn, Corvallis, OR (US)

(21) Appl. No.: 13/308,045

(22) Filed: Nov. 30, 2011

(51) Int. Cl. G01C 9/06; G06F 15/00

(52) U.S. Cl. 702/154; 33/366.26

(57) ABSTRACT

An inclinometer and method for use in the same are disclosed herein. An example of such an inclinometer includes a substrate and a heater on the substrate. The inclinometer also includes a plurality of fluid passageways coupled to the substrate and configured to conduct fluid past the heater to an exit. The inclinometer additionally includes a. temperature sensor adjacent the exit which is configured to measure a temperature in each of the fluid passageways. The inclinometer may further include a processor coupled to the temperature sensor to receive the temperature measured in each of the fluid passageway's which is configured to determine an angle of inclination based on the measured temperatures. A non-transitory computer readable storage medium may store instructions that, when executed by the processor, cause the processor to determine the angle of inclination based on the measured temperatures.

### BACKGROUND

Electrical power consumption for end users (e.g., consumers, businesses, and government) and structures is delivered by a power distribution system. A power distribution system may include numerous components, such as power lines, towers, poles, transformers, etc. Faults in such distribution systems do occur, which can result in a power outage, thereby preventing power delivery. Power outages may occur due to events such as inclement weather (e.g., snow, ice, high wind, etc.), falling tree branches that knock down power lines, vandalism, terrorism, or failing power distribution components. It is desirable for a power provider to quickly identify and respond to such power distribution events to minimize the adverse impact to end users and structures, as well as to minimize financial losses.

### BRIEF DESCRIPTION OF THE DRAWINGS

The following detailed description references the drawings, wherein:

FIG. 1 is an example of a inclinometer.

FIG. 2 is an example of an application of the inclinometer shown in FIG. 1.

FIG. 3 is an additional example of an application of the inclinometer shown in FIGS. 1 and 2.

FIG. 4 is an example of a cross-sectional view taken along line 4-4 of FIG. 1.

FIG. 5 is an example of a cross-sectional view taken along line 5-5 of FIG. 1.

FIG. 6 is an example of a block diagram of control electronics for use with the inclinometer of FIGS. 1-5.

FIG. 7 is an example of a housing for use with the inclinometer and control electronics illustrated in FIGS. 1-6.

FIG. 8 is an example of an inclinometer and control electronics.

FIG. 9 is an example of a method for use in an inclinometer.

FIG. 10 is an example of additional elements of the method for use in an inclinometer.

### DETAILED DESCRIPTION

When a power outage occurs, a power provider is under pressure both to quickly identify that an event has occurred and to locate the point of such outage. This allows the power provider to deploy the necessary resources to restore service. This is particularly true after bad weather (e.g., snow, ice, high wind, etc.), a natural disaster (e,g., hurricane, tornado, earthquake, flood, etc.), terrorism, or vandalism which may have downed powerlines or caused other power distribution system components to fail at one or more multiple locations.

In to repairing faulty power distribution systems, maintaining them in effective working order is also important, both for end users and society, as well as the financial interests of the power provider. Maintenance is used to identify signs of potential failure and repair them prior to actual failure. Here again, determining the location of such potentially needed maintenance is desirable.

Tilting poles, towers or other supports are one way in which a power distribution system can or may fail. Devices that might be utilized to detect such tilting contain some physical element (e.g., pendulum, mercury bead, etc.), the movement of which is converted to an angular measurement. Devices with moving parts tend to be less reliable in harsh environments, exactly the conditions of concern in power distribution over a large grid. Additionally, such devices can be expensive, particularly in the large quantities often required.

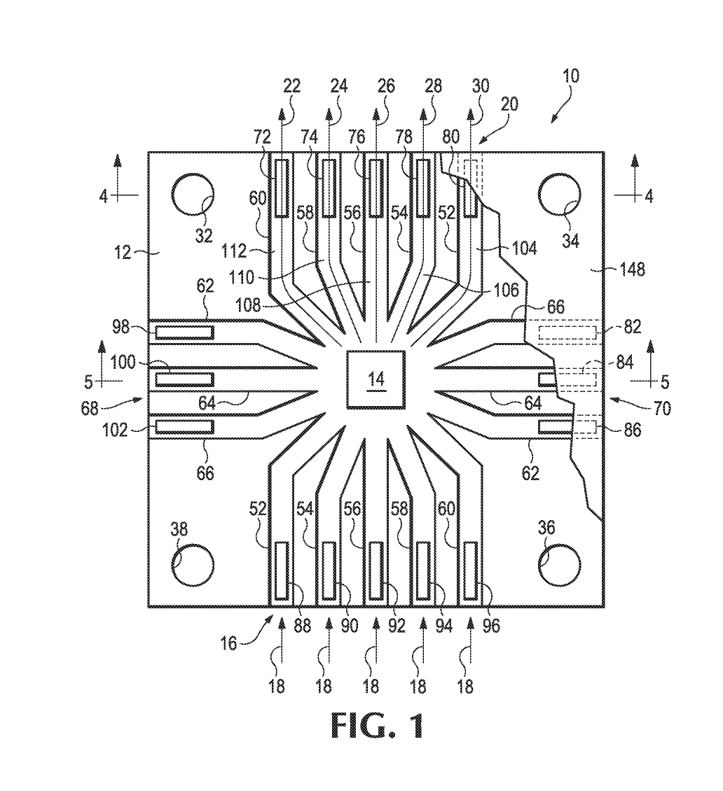

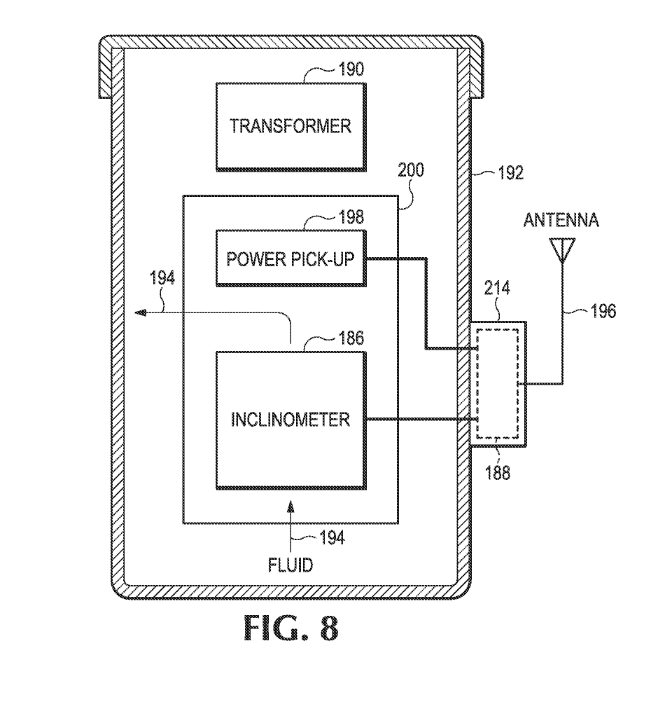

An example of a tilt sensor or inclinometer without any moving parts is shown in FIG. 1. Inclinometer 10 includes a substrate or base 12 and a heater 14 adjacent to or on substrate or base 12. Substrate or base 12 includes an entrance, generally indicated by arrow 16, into which a fluid 18 may flow and an exit 20 out of which portions of fluid 18 may exit, as generally indicated by arrows 22, 24, 26, 28, and 30 (discussed in more detail below). In the example of inclinometer 10 shown in FIG. 1, fluid 18 is illustrated as air. It is to be understood, however, that other designs in accordance with the present invention may utilize different fluids, such as liquids. One such example is shown in FIG. 8 and discussed in more detail below.

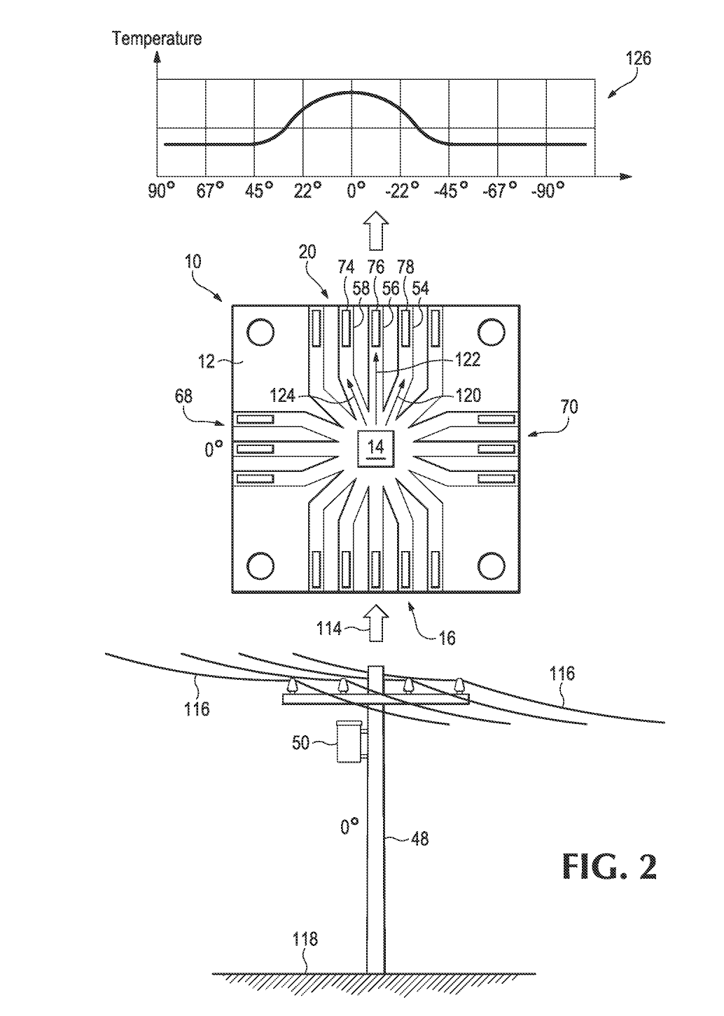

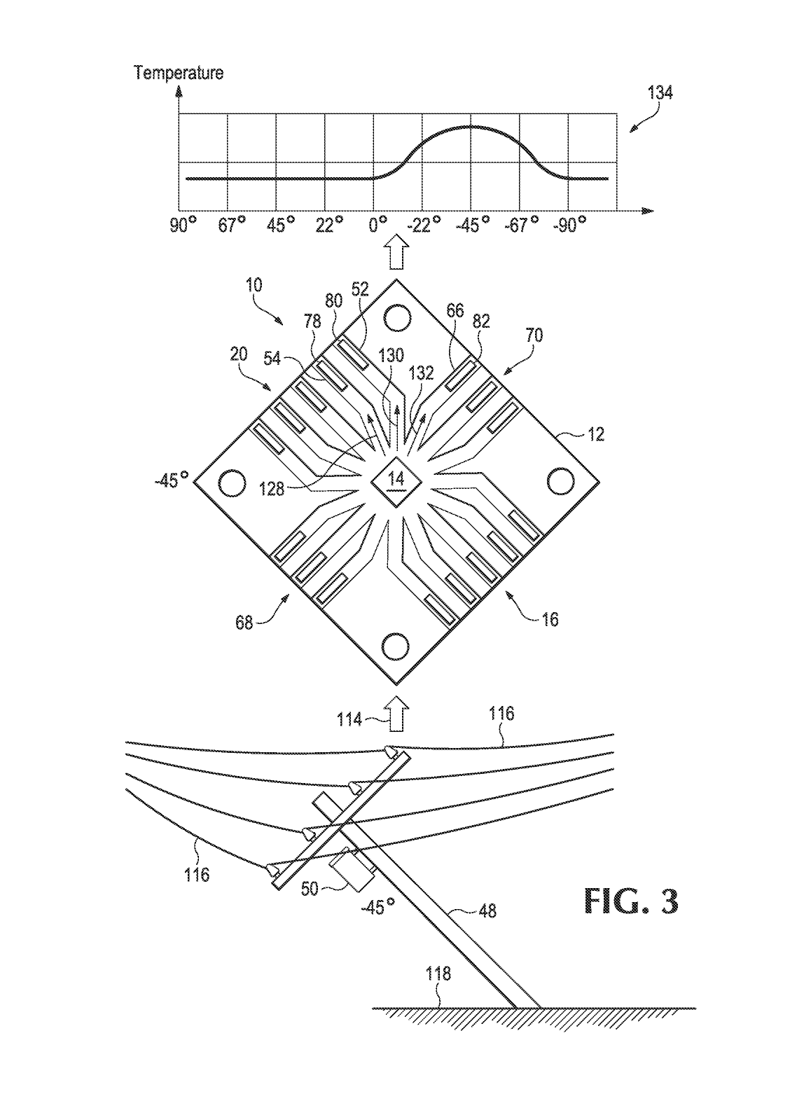

Substrate or base 12 is configured to define one or more apertures or openings 32, 34, 36, and 38. Apertures or openings 32, 34, 36, and 38 are designed to each receive a respective fastener 40, 42, 44, and 46 (see FIG. 7) to help mount inclinometer 10 to a power distribution component such a pole 48 (see FIGS. 2 and 3) or a transformer 50. Although apertures or openings 32, 34, 36, and 38 are shown, it is to be understood that different mounting or attaching means may be used in other examples of inclinometer 10. For example, adhesive, straps, hook and loop, etc.

Referring again to FIG. 1, inclinometer 10 additionally includes a plurality of fluid passageways 52, 54, 56, 58, and 60 coupled to substrate or base 12 each of which are configured to conduct fluid 18 from entrance 16 past heater 14 to exit 20. Inclinometer 10 further includes fluid passageways 62, 64, and 66 coupled to substrate or base 12 each of which, depending on the orientation of inclinometer 10, are also configured to conduct fluid (not shown in FIG. 1) from entrance 68 past heater 14 to exit 70, as discussed more fully below.

Inclinometer 10 further includes a plurality of temperature sensors 72, 74, 76, 78, and 80 adjacent exit 20 each of which is configured to measure a temperature in respective fluid. passageways 60, 58, 56, 54, and 52. As can be seen in FIG, 1, inclinometer 10 also includes temperature sensors 82, 84, and 86 adjacent exit 70 each of which is configured to measure a temperature in respective fluid passageway 66, 64, and 62. Temperature sensors 88, 90, 92, 94, and 96 may be included adjacent entrance 16 to measure a temperature of fluid 18 as it enters respective fluid passageways 52, 54, 56, 58, and 60. Additionally, temperature sensors 98, 100, and 102 may be included adjacent entrance 68 to measure a temperature of a fluid (not shown in FIG. 1) as it enters respective fluid passageways 62, 64, and 66. Temperature sensors 72, 74, 76, 78, 80, 82, 84, 86, 88, 90, 92, 94, 96, 98, 100, and 102 may include any of a variety of components such as thermocouples.

As can be seen in FIG. 1, each of fluid passageways 52, 54, 56, 58, and 60 are configured to define a respective flowpath 104, 106, 108, 110, and 112 each of which conducts a portion of warmed fluid 18 to exit 20, as generally indicated by arrows 22, 24, 26, 28, and 30. Although not shown in FIG. 1, it is to be understood that similar flowpaths also exist fur each of fluid passageways 62, 64, and 66. As can also be seen in FIG. 1, each of fluid passageways 52, 54, 56, 58, and 60 has a different shape relative to one another. Similarly, each of fluid passageways 62, 64, and 66 has a different shape relative to one another.

As discussed more fully below, one reason why fluid passageways 52, 54, 56, 58, and 60 as well as fluid passageways 62, 64, and 66 are shaped differently with respect to one another is to help indicate an angle of inclination based on the measured temperature therein, For the example of inclinometer 10 shown in FIG. 1, fluid passageway 52 is configured to indicate an approximate angle of inclination of plus forty-five degrees (+45°), fluid passageway 54 is configured to indicate an approximate angle of inclination of plus twenty-two degrees (+22°), fluid passageway 56 is configured to indicate an approximate angle of inclination of zero degrees)(0°), fluid passageway 58 is configured to indicate an approximate angle of inclination of negative twenty-two degrees (−22°), and fluid passageway 60 is configured to indicate an approximate angle of inclination of negative forty-five degrees (−45′).

Additional angles of inclination are determined by the configuration of fluid passageways 62, 64, and 66. For the example of inclinometer 10 shown in FIG. 1, fluid passageway 66 is configured to indicate an approximate angle of inclination of plus or minus sixty-seven degrees (+67°), fluid passageway 64 is configured to indicate an approximate angle of inclination of plus or minus ninety degrees (+90°), and fluid passageway 62 is configured to indicate an approximate angle of inclination of plus or minus one hundred and twelve degrees (±112°).

An example of an application of inclinometer 10 is shown in FIG. 2, As can be seen in FIG. 2, inclinometer 10 is deployed on a power distribution pole 48, as generally indicated by arrow 114, which supports powerlines 116 of a power distribution system. Inclinometer 10 is utilized to measure the amount of tilt or angle of pole 48 relative to ground 118, zero degrees (0°) in this example. This helps indicate whether a power distribution system fault has occurred. It also helps indicate whether a power distribution system fault may occur so that appropriate maintenance can be performed.

As discussed above, temperature sensors 74, 76, and 78, are each configured to measure a temperature in respective fluid passageways 58, 56, and 54. This temperature varies based upon the quantity of warmed fluid that is conducted through each of the fluid passageways. The larger the quantity of warmed fluid that is conducted by a particular temperature sensor, the higher the measured temperature. The quantity of the warmed fluid that is conducted through each of the fluid passageways is, in turn, controlled by the relative orientation of these passageways as warmed fluid 18 rises and travels through the different flowpaths 120, 122, and 124 of respective fluid passageways 54, 56, and 58 towards exit 20, The relatively uppermost one of these fluid passageways receives the majority of warmed fluid 18. The angle of inclination or angular orientation can then be identified by determining the maximum of these different temperatures in the various fluid passageways. For example, as shown in temperature versus angle of inclination graph 126 in FIG. 2, the highest relative temperature differential is in fluid passageway 56 which is configured to represent a angle of inclination of approximately zero degrees (0°).

An additional example of the application of inclinometer 10 is shown in FIG. 3. As can be seen in FIG. 3, inclinometer 10 is utilized to measure the amount of tilt or angle of pole 48 relative to ground 118, negative forty-five degrees (−45°) in this example. This helps indicate that a power distribution system fault may occur and that appropriate maintenance should therefore be performed, If such maintenance is not performed the angle of inclination of pole 48 could increase further until pole 48 reaches ground 118 or powerlines 116 break or short, both of which could potentially disrupt a power distribution service.

As discussed above, temperature sensors 78, 80, and 82 are each configured to measure a temperature in respective fluid passageway's 54, 52, and 66. This temperature varies based upon the quantity of warmed fluid that is conducted through each of the fluid passageways. The larger the quantity of warmed fluid that is conducted by a particular temperature sensor, the higher the measured temperature. The quantity of the warmed fluid that is conducted through each of the fluid passageways is, in turn, controlled by the relative orientation of these passageways as warmed fluid 18 rises and travels through the different flowpaths 128, 130, and 132 of respective fluid passageways 54, 52, and 66. The relatively uppermost one of these fluid passageways receives the majority of warmed fluid 18. The angle of inclination or angular orientation can then be identified by determining the maximum of these different temperatures in the various fluid passageways, For example, as shown in temperature versus angle of inclination graph 134 in FIG. 3, the highest relative temperature differential is in fluid passageway 52 which is configured to represent an angle of inclination f approximately minus forty-five degrees (−45°).

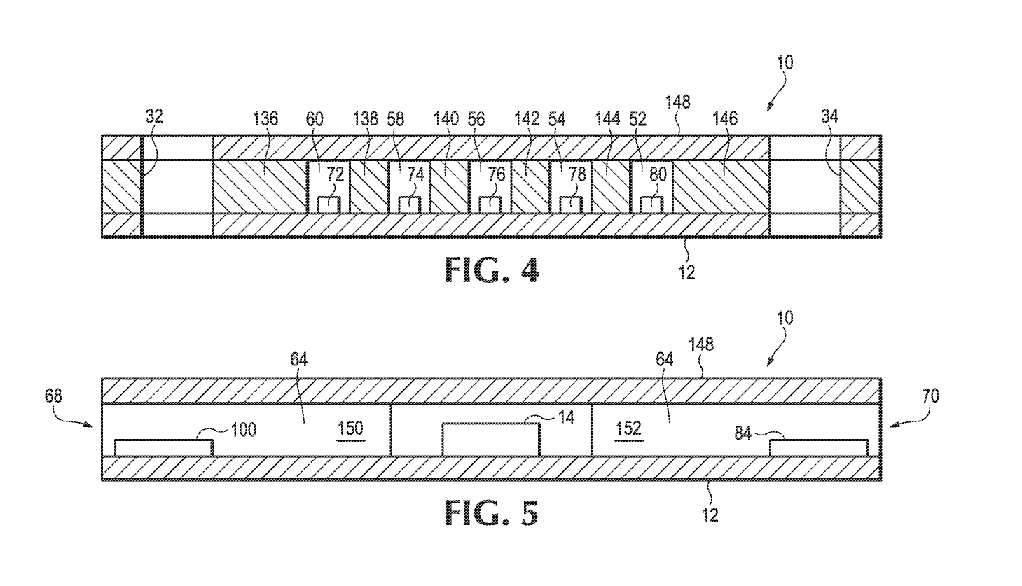

An example of a cross-sectional view of inclinometer 10 taken along line 4-4 of FIG. 1 is shown in FIG, 4. Fluid passageways 52, 54, 56, 58, and 60 can be seen, as can respective temperature sensors 80, 78, 76, 74, and 72 adjacent or on base or substrate 12. As can be seen in FIG. 4, each of fluid passageways 52, 54, 56, 58, and 60 are partially defined by a pair of walls or upright members 136, 138, 140, 142, 144, and 146 (one on either side of a each passageway). The remainder of each of fluid passageways 52, 54, 56, 58, and 60 are defined by base 12 and lid or cover 148, as shown.

An example of a cross-sectional view of inclinometer 10 taken along line 5-5 of FIG. 1 is shown in FIG. 5. Heater 14 which is on or adjacent to base or substrate 12 can be seen, as can temperature sensors 84 and 100 which are also on or adjacent to base or substrate 12. The entire extent of fluid passageway 64 from entrance 68 to exit 70 can also be seen, as can two walls or upright members 150 and 152 that help to define it along with two others (not shown in FIG. 5). The definition of fluid passageway 64 is completed by base or substrate 12 and lid or cover 148.

The various components that comprise inclinometer 10 can be made from a variety of suitable materials. For example, base or substrate 12 can be configured from a semiconductor material as can lid or cover 148. Each of the ails or upright members that help define the various fluid passageways 52, 54, 56, 58, 60, 62, 64, and 66 (e.g., walls or upright members (36, 138, 140, 142, 144, 146, 150, and 152) may also be configured from a semiconductor material. As another example, heater 14 can be configured from a thin-film material. This flexibility in material selection and use allows inclinometer 10 to be configured in a range of different sizes and shapes, as well as designed to operate in a range of ambient conditions. For example, in one application, inclinometers of the present invention constructed from semiconductor and thin-film materials described above, can range in size from 0.5 inches×0.5 inches to the size of a typical head of a pin. Other larger or smaller sizes are also possible and the inclinometer of the present invention is not limited to this example range.

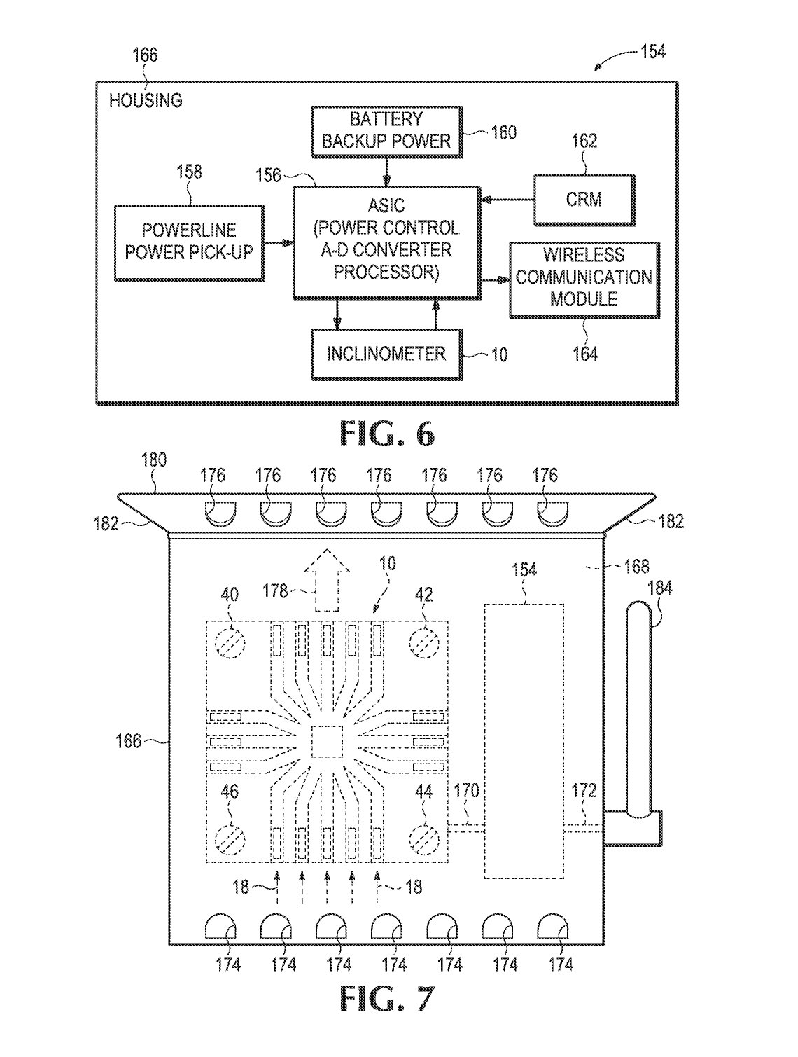

FIG. 6 is an example of a block diagram of control electronics 154 for use with the inclinometer 10 of FIGS. 1-5. As can be seen in FIG. 6, control electronics 154 include an application specific integrated circuit (ASIC) 156 that is designed to include a processor and other components or modules for functions such as analog-to-digital (A-D) conversion, power control, etc. As can be seen in FIG. 6, ASIC 156 is coupled to inclinometer 10 so that the processor therein can determine the angle of inclination based on the different temperatures measured within inclinometer 10. As discussed above, this can be accomplished through a determination of the uppermost one of the various fluid passageways of inclinometer 10.

Power is supplied via a powerline pick-up 158 that electromagnetically couples to powerlines 116. Backup power is provided by a battery 160 in the event of a power distribution system failure. Control electronics 154 additionally include a non-transitory computer readable storage medium (CRM) 162, CRM 162 stores instructions that, when executed by the processor of ASIC 156, cause the processor to determine the angle of inclination based on the temperatures measured within inclinometer 10. As discussed above, this cat be accomplished through a determination of the uppermost one of the various fluid passageways of inclinometer 10.

A wireless communication nodule 164 is used to transmit information to a power distribution system control center including information concerning inclination angle. Finally a housing 166 protects control electronics 154 from the ambient environment while still allowing inclinometer 10 to function properly.

An example of housing 166 is shown in FIG. 7. Housing 166 includes an interior 168 in which inclinometer 10 and control electronics 154 are mounted to shield them and interconnecting cables 170 and 172 from the ambient environment. As can be seen in FIG. 7, housing 166 includes a plurality of entrance vents 174 formed therein that allow fluid 18 to enter interior 168 for use by inclinometer 10. Housing 166 additionally includes a plurality of exit vents 176 through which warmed fluid, generally indicated by arrow 178, exits from inclinometer 10 and interior 168.

As can also be seen in FIG. 7, housing 166 includes a roof or top 180 that is configured to include sloping sides 182 in which exit vents 176 may be formed. Sloping sides 182 help protect or shield interior 168 from the ambient elements such as rain. Housing 166 is additionally configured to include a mount for antenna 184. Antenna 184 is used to transmit information to a power distribution system control center (not shown) including information concerning inclination angle.

An example of another application of an inclinometer 186 and control electronics 188 is shown in FIG. 8. As can be seen in FIG. 8, this particular application includes a transformer 190 which may be mounted, for example, on a pole or tower (not shown in FIG. 8) via housing 192. Transformer 190 may be a component of a power distribution system (not shown). In this application, inclinometer 186 is used to measure the angle of inclination of transformer 190 to alert of a possible failure or the need for potential maintenance. Additionally, inclinometer 186 is used to measure and monitor a temperature of a fluid 194 in which transformer 190 is maintained. This temperature information can also be transmitted along with angle of inclination data via antenna 196 to a power distribution system control center (not shown) and be used to alert of a possible failure or the need for potential maintenance. In this application, fluid 194 is a liquid, rather than air, which circulates through inclinometer 186 via openings (not shown) in housing 200, as generally indicated by arrows 194 in FIG. 8.

Power is supplied via a power pick-up 198 that is electromagnetically coupled to transformer 190. Control electronics 188 may include the other components discussed above in connection with FIG. 6 such as an electromagnetic transformer power pick-up, an ASIC with a processor, battery backup power, a non-transitory computer readable storage medium (CRM), and wireless communication module. A housing 214 protects control electronics 188 from the ambient environment.

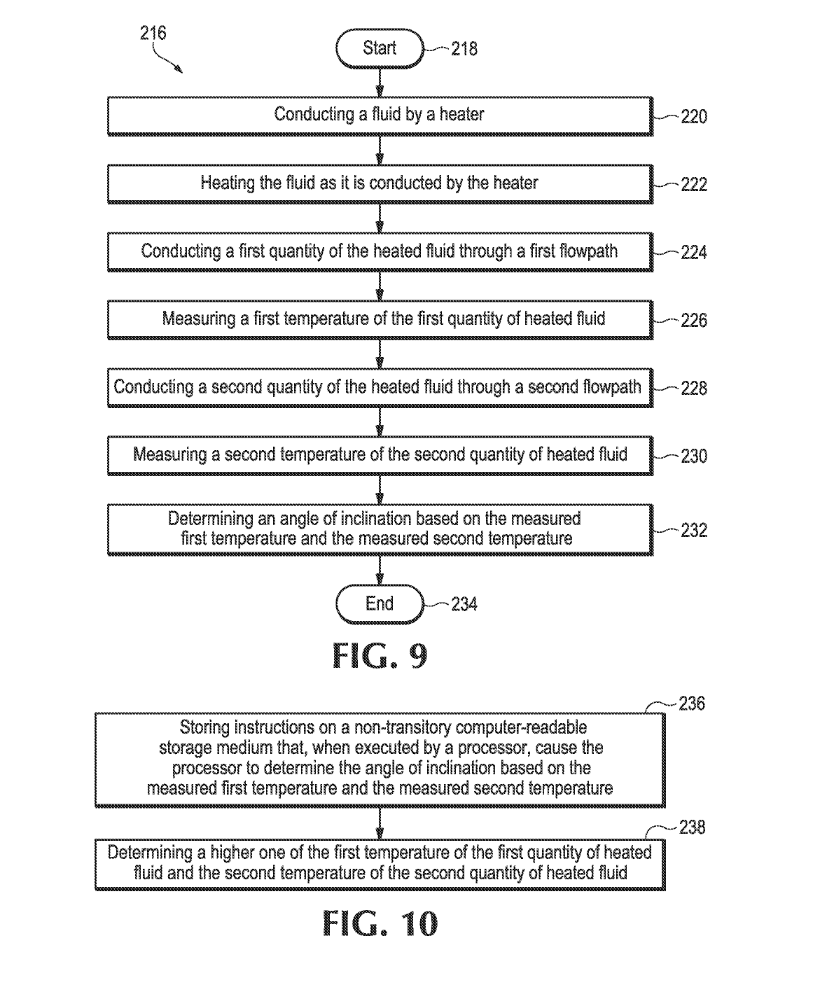

An example of a method 216 for use in an inclinometer is shown in FIG. 9. Method 216 starts 218 by conducting a fluid by a heater 220 and heating the fluid as it is conducted by the heater 222. Method 216 continues by conducting a first quantity of the heated fluid through a first flowpath 224 and measuring a first temperature of the first quantity of heated fluid 226. Next, method 216 continues by conducting a second quantity of the heated fluid through a second flowpath 228 and measuring a second temperature of the second quantity of heated fluid 230. Method 216 then continues by determining an angle of inclination based on the measured first temperature and the measured second temperature 232 and may then end 234.

An example of additional elements of method 216 for use in an inclinometer is shown in FIG. 10, Method 216 may additionally continue by storing instructions on a non-transitory computer-readable storage medium that, when executed by a processor, cause the processor to determine the angle of inclination based on the measured first temperature and the measured second temperature 236, Method 216 may further continue by determining a higher one of the first temperature of the first quantity of heated fluid and the second temperature of the second quantity of heated fluid 238.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art, For example, additional fluid passageways may be utilized in other examples of the inclinometer to increase the accuracy of angular measurement. Additionally, one or more of the fluid passageways can be shaped differently than as shown. As another example, the range of angles of inclination that can be determined may be greater or lesser in other examples of the inclinometer. As a further example, the inclinometer can be used in other applications such as elevated water tanks, grain silos, refinery stacks, highway overpasses, bridges, dams, buildings, cell phone towers, and antennas, As yet a further example, the inclinometer can be shaped differently than as a rectangle (e.g., oval, circular, triangular, etc.), as shown. The spirit and. scope of the present invention are to be limited only by the terms of the following claims.

Additionally, reference to an element in the singular is not intended to mean one and only one, unless explicitly so stated, hut rather means one or more. Moreover, no element or component is intended to be dedicated to the public regardless of whether the element or component is explicitly recited in the following claims.

What is claimed is:

1. An inclinometer, comprising:
a substrate;
a heater on the substrate;
a plurality of fluid passageways coupled to the substrate and configured to conduct fluid past the heater to an exit; and
a temperature sensor adjacent the exit and configured to measure a temperature in each of the fluid passageways.

2. The inclinometer of claim 1, wherein the substrate is configured to include a plurality of openings through which the fluid flows from an entrance to the exit.

3. The inclinometer of Claim 1, wherein the temperature sensor includes a thermocouple in each of the fluid passageways.

4. The inclinometer of Claim 1, wherein each of the fluid passageways is further configured to indicate an angle of inclination based on the temperature therein.

5. The inclinometer of claim 1, wherein the substrate and fluid passageways are further configured from a semiconductor material and the heater is configured from a thin-film material.

6. The inclinometer of claim 1, further comprising a processor coupled to the temperature sensor to receive the temperature measured in each of the fluid passageways and configured to determine an angle of inclination based on the measured temperatures.

7. The inclinometer of claim 6, further comprising a non-transitory computer readable storage medium storing instructions that, when executed by the processor, cause the processor to determine the angle of inclination based on the measured temperatures.

8. An inclinometer, comprising:
a base configured to include an exit;
a heater adjacent adjacent the base;
a first fluid passageway coupled to the base and configured to define a first flowpath that conducts a first portion of a warmed fluid from the heater to the exit; and
a second fluid passageway coupled to the base and configured to define a second flowpath that conducts the warmed fluid from the heater to the exit;
wherein the first fluid passageway and the second fluid passageway are each configured so that a majority of the warmed fluid is conducted to the exit by an uppermost one of the first fluid passageway and the second fluid passageway.

9. The inclinometer of claim 8, wherein the uppermost one of the first fluid passageway and the second fluid passageway is dependent on an angular orientation of the base.

10. The inclinometer of claim 8, wherein the first fluid passageway is further configured to have a first shape and the second fluid passageway is configured to have a second different shape.

11. The inclinometer of claim 8, further comprising a temperature sensor adjacent the exit and configured to measure a first temperature in the first fluid passageway and a second temperature in the second fluid passageway.

12. The inclinometer of claim 8, wherein the temperature sensor includes a first thermocouple in the first fluid passageway and a second thermocouple in the second fluid passageway.

13. The inclinometer of claim 8, wherein the base, the first fluid passageway, and the second fluid passageway are further configured from a semiconductor material, and further wherein the heater is configured from a thin-film material.

14. The inclinometer of claim 8, further comprising a processor configured to determine the uppermost one of the first fluid passageway and the second fluid passageway.

15. The inclinometer of claim 14, further comprising a non-transitory computer readable storage medium storing instructions that, when executed by the processor, cause the processor to determine the uppermost one of the first fluid passageway and the second fluid passageway.

16. The inclinometer of claim 14, wherein the processor is further configured to calculate an angle of inclination of the base from the determined uppermost one of the first and second fluid passageways.

17. The inclinometer of claim 16, further comprising a non-transitory computer readable storage medium storing instructions that, when executed by the processor, cause the processor to determine the angle of inclination of the base.

18. A method for use in an inclinometer, comprising:
conducting a fluid by a heater;
heating the fluid as it is conducted by the heater;
conducting a first quantity of the heated fluid through a first flowpath;
measuring a first temperature of the first quantity of heated fluid;
conducting a second quantity of the heated fluid through a second flowpath;
measuring a second temperature of the second quantity of heated fluid; and
determining an angle of inclination based on e measured first temperature and the measured second temperature.

19. The method of claim 18, further comprising storing instructions on a non-transitory computer-readable storage medium that, when executed by a processor, cause the processor to determine the angle of inclination based on the measured first temperature and the measured second temperature.

20. The method of claim 18, further comprising determining a higher one of the first temperature of the first quantity of heated fluid and the second temperature of the second quantity of heated fluid.
